(19) United States
(12) Patent Application Publication
(10) Pub. No.: US 2026/0043492 A1
(43) Pub. Date: Feb. 12, 2026

(54) STRUCTURAL COMPONENT

(71) Applicant: NIFCO INC., Yokosuka-shi (JP)

(72) Inventors: Yoshimi ARAI, Yokosuka-shi (JP); Ryosuke YAMADA, Yokosuka-shi (JP)

(21) Appl. No.: 19/271,796

(22) Filed: Jul. 17, 2025

(30) Foreign Application Priority Data
Aug. 6, 2024 (JP) 2024-130052

(51) Int. Cl. F16K 27/02; F16K 7/17; H01M 50/333

(52) U.S. Cl. CPC F16K 27/0236; F16K 7/17; H01M 50/333

(57) ABSTRACT

A structural component is attached to a surface of a target object and has a flow path. The structural component includes a case including a communicating portion communicating with the flow path of the target object; a valve member including a cover covering the communicating portion in a closed position, the valve member being movable from the closed position to open the communicating portion; and a gasket to be interposed between the surface of the target object and the case and to surround the flow path in a plan view. The case includes a sidewall surrounding the gasket in a plan view, and a shield portion blocking a fluid from traveling from the outside of the structural component toward the gasket through the drain portion. The sidewall includes a drain portion communicating a gap between the sidewall and the gasket with an outside of the structural component.

### CROSS-REFERENCE TO RELATED APPLICATION

The present application claims priority of Japanese Patent Application No 2024-130052 filed on Aug. 6, 2024, the disclosure of which is incorporated herein.

### BACKGROUND OF THE INVENTION

### 1. Field of the Invention

The present invention relates to a structural component attached to a surface of a target object provided with a flow path.

### 2. Description of the Related Art

A pressure relief valve is sometimes connected to an interior of an automobile. The pressure relief valve includes a case having a communicating portion for causing an internal space of the pressure relief valve to communicate with an external space, a valve member that opens and closes the communicating portion, and a gasket positioned between the case and a surface of a target object, on which the pressure relief valve is attached. The pressure relief valve is connected, for example, to a battery pack installed in an automobile. In this case, the pressure inside the battery pack can be regulated by the pressure relief valve.
Patent Literature 1: Japanese Patent No. 7059226

External liquid sometimes enters an interior of the pressure relief valve (structural component) through a gap between the case and the valve member. In order to drain the liquid that has entered the interior, it is conceivable to provide, to the case, a drain portion for draining the liquid from the interior. Meanwhile, pressure relief valves are sometimes hit by fluid traveling outside. For example, when the target object attached with the pressure relief valve is cleaned by a high-pressure washer, the pressure relief valve is possibly subjected to water jet released by the high-pressure washer. In this case, the pressure relief valve is possibly hit by water. If the drain portion is provided to the case of the pressure relief valve, it is possible that the fluid that travels outside the pressure relief valve and hits the pressure relief valve enters the case through the drain portion to directly strike on the gasket.

### SUMMARY OF THE INVENTION

An object of the present invention is to provide a structural component that can solve the above problem.

The present invention relates to the following [1] to [8].
[1] A structural component attached to a surface of a target object including a flow path, the structural component including:
a case including a communicating portion that communicates with the flow path of the target object;
a valve member including a cover that covers the communicating portion in a closed position, the valve member being movable from the closed position to open the communicating portion; and
a gasket surrounding the flow path in a plan view, the gasket being interposed between the surface of the target object and the case, in which
the case includes a sidewall surrounding the gasket in a plan view,
the sidewall includes a drain portion configured to cause a gap between the sidewall and the gasket to communicate with an outside of the structural component, and
the case further includes a shield portion that blocks a fluid from traveling from the outside of the structural component toward the gasket through the drain portion.
[2] In the structural component according to [1],
the drain portion may include a first end, which is an end in a circumferential direction along a circumference of the structural component in a plan view, and a second end opposite
the first end in the circumferential direction, and the shield portion may overlap an entirety of the drain portion when viewed in a direction perpendicular to a straight line connecting the first end and the second end.
[3] In the structural component according to [1] or [2],
the drain portion may include a first end, which is an end in the circumferential direction along a circumference of the structural component in a plan view, and a second end opposite the first end in the circumferential direction, and
the shield portion may be connected to the first end.
[4] In the structural component according to [3],
the case may further include a fastening portion interposed between the sidewall and the gasket and fastened to the surface of the target object, and
in a plan view, a distance between the second end and the fastening portion may be smaller than a distance between the first end and the fastening portion.
[5] In the structural component according to any one of [1] to [4],
the sidewall may include a corner portion protruding toward the outside of the structural component in a plan view,
the case may further include a fastening portion provided between the corner portion of the sidewall and the gasket and fastened to the surface of the target object, and
the sidewall may include the drain portion at the corner portion.
[6] In the structural component according to any one of [1] to [5],
the sidewall may include a sidewall end facing the surface of the target object when the structural component is attached to the surface of the target object, and
the drain portion may be a notch formed in the sidewall end.
[7] In the structural component according to any one of [1] to [6],
the structural component may further include a second gasket interposed between the case and the valve member, the second gasket surrounding the communicating portion in a plan view, and
the case may further include a groove portion that is open to the cover of the valve member to receive the second gasket and a hole provided in a face of the groove portion to cause the groove portion to communicate with the gap between the sidewall and the gasket.
[8] In the structural component according to any one of [1] to [7], the target object may be an enclosure of a battery pack.

According to the present invention, the gasket can be prevented from being directly hit by fluid traveling outside the structural component.

### BRIEF DESCRIPTION OF THE DRAWINGS

FIG. 1 is a perspective view illustrating an example of a structural component and a target object.

FIG. 2 is a plan view illustrating the example of the structural component.

FIG. 3 is a side view illustrating the example of the structural component.

FIG. 4 is a perspective view illustrating an example of a case, a gasket, and a second gasket.

FIG. 5 is a perspective view illustrating the example of the case, the gasket, and the second gasket.

FIG. 6 is a cross-sectional view illustrating the structural component taken along VI-VI line in FIG. 2.

FIG. 7 is a cross-sectional view illustrating the structural component taken along VII-VII line in FIG. 2.

FIG. 8 is a cross-sectional view of an example of the structural component attached to the target object.

FIG. 9 is a perspective view illustrating a part of FIG. 4 in an enlarged manner.

FIG. 10 is a plan view illustrating one of drain portions and one of shield portions along with a nearby sidewall.

FIG. 11 is a cross-sectional view of a structural component of a comparative example attached to a target object.

FIG. 12 is a cross-sectional view illustrating an example of an operation of the pressure relief valve.

### DETAILED DESCRIPTION OF EMBODIMENTS

An exemplary embodiment of the present invention will be described below with reference to attached drawings. In the drawings attached to the present specification, the scale, the ratio of length to width and height, and the like have been changed and exaggerated from those of the actual products as appropriate for the sake of easy understanding.

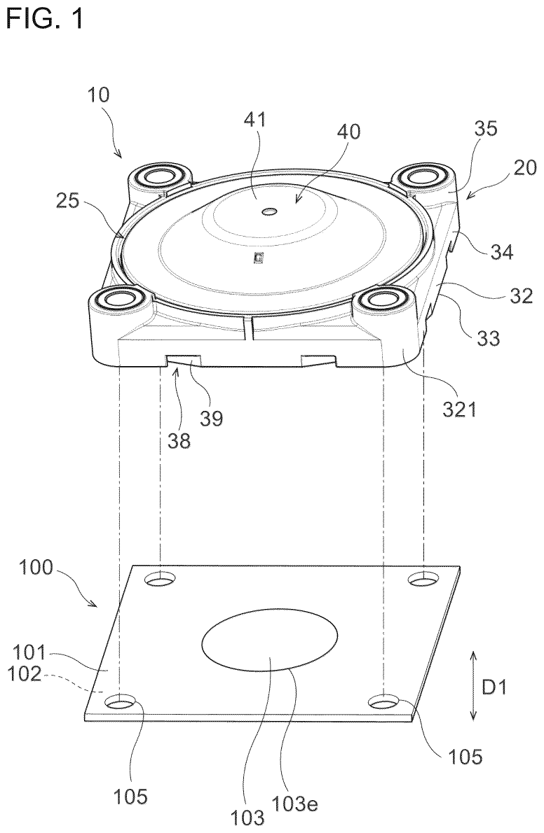

FIG. 1 is a perspective view illustrating an example of a structural component 10 and a target object 100. The structural component 10 is attached to a top surface 101 of the target object 100 that includes a flow path 103. In the example of FIG. 1, the target object 100 is an enclosure of a battery pack and the structural component 10 is a pressure relief valve mounted on the enclosure. The pressure relief valve is a device used to regulate the pressure inside the battery pack. For example, the pressure relief valve operates to release a fluid (e.g., a gas inside a battery pack) to the outside when the pressure inside the battery pack exceeds a threshold. Devices, such as battery cells, are housed inside the battery pack.

The target object 100 has the top surface 101, a back surface 102, and the flow path 103. The flow path 103 is a structure for releasing a fluid (e.g., the gas inside the target object 100) to the outside. The flow path 103 is, for example, an opening penetrating the enclosure of the target object 100. The flow path 103 is covered with the structural component 10. The structural component 10 overlaps an outer edge 103e of the flow path 103 in a plan view. The term “in a plan view” herein means that an object is viewed along a normal direction of the top surface 101 of the target object 100. The top surface 101 faces the structural component 10. The back surface 102 is located opposite the top surface 101 in the thickness direction.

The target object 100 has a plurality of fastening holes 105. Fasteners are inserted into the fastening holes 105 to fix the structural component 10 to the target object 100. Examples of the fasteners include bolts.

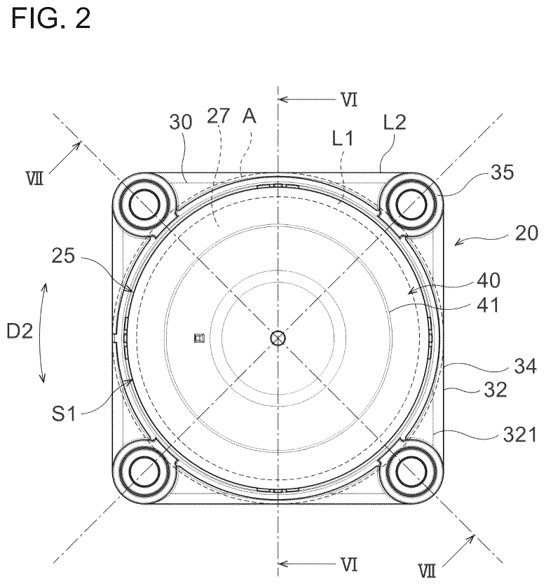

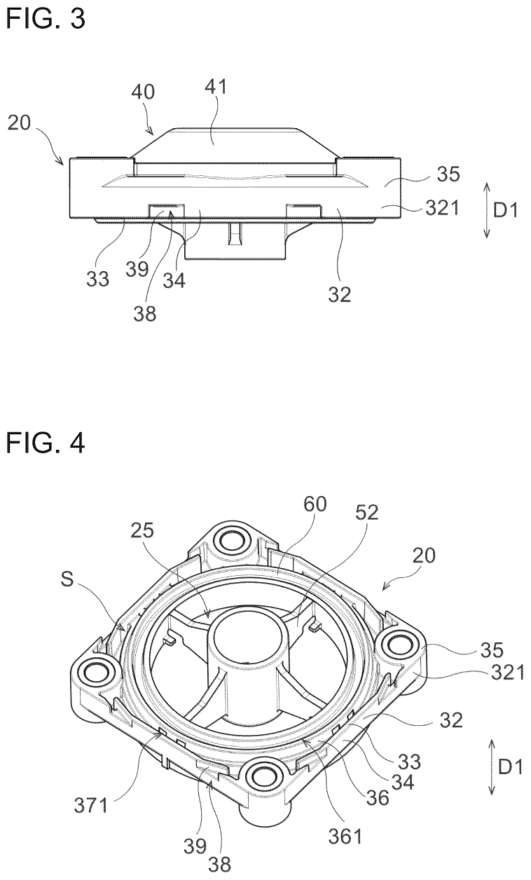

FIG. 2 is a plan view illustrating the example of the structural component 10. FIG. 2 corresponds to an illustration illustrating the structural component 10 in a plan view. FIG. 3 is a side view illustrating the example of the structural component 10. As illustrated in FIGS. 1 to 3, the structural component 10 includes a case 20 and a valve member 40.

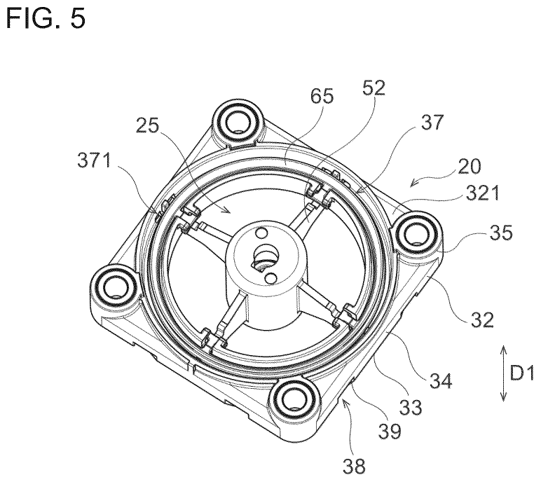

Although not illustrated in FIG. 1, the structural component 10 further includes a gasket 60. Although not illustrated in FIG. 1, the structural component 10 further includes a second gasket 65. FIG. 4 is a perspective view illustrating the case 20 and the gasket 60 of the structural component 10 viewed from a side facing the top surface 101 when the structural component 10 is fixed to the top surface 101 of the target object 100. FIG. 5 is a perspective view illustrating the case 20 and the second gasket 65 of the structural component 10 viewed from a side opposite the side facing the top surface 101 when the structural component 10 is fixed to the top surface 101 of the target object 100. The gasket 60 is interposed between the top surface 101 of the target object 100 and the case 20. The gasket 60 surrounds the flow path 103 in a plan view. The gasket 60 is in close contact with the case 20 and the top surface 101 when the structural component 10 is attached to the top surface 101 of the target object 100 to provide a tight seal between the case 20 and the top surface 101. In the present exemplary embodiment, the gasket 60 has an annular shape. The second gasket 65 is interposed between the case 20 and the valve member 40. In a plan view, the second gasket 65 surrounds a later-described communicating portion 25 of the case 20. The second gasket 65 is in close contact with the case 20 and the cover 41 of the valve member 40 when the valve member 40 is in a closed position to provide a tight seal between the case 20 and the cover 41 of the valve member 40. In the present exemplary embodiment, the second gasket 65 has an annular shape.

The case 20 of the present exemplary embodiment has an outer portion 30 and an inner portion 27. The outer portion 30 is a part of the case 20 located outside an outer profile L1 of the gasket 60 in a plan view. The location of the outer profile L1 of the gasket 60 is illustrated by a dashed line with a symbol “L1” in FIG. 2. In the example illustrated in FIG. 2, the outer profile L1 of the gasket 60 is circular in a plan view. The term “outer” refers to a direction away from the center of the flow path 103 in a plan view. The inner portion 27 is a part of the case 20 located inside the outer profile L1 of the gasket 60 in a plan view. The term “inner” refers to a direction toward the center of the flow path 103 in a plan view.

The case 20 includes the communicating portion 25, a sidewall 32, a fastening portion 35, and a shield portion 39. The communicating portion 25 of the case 20 of the present exemplary embodiment is provided in the inner portion 27. The sidewall 32, the fastening portion 35, and the shield portion 39 of the case 20 of the present exemplary embodiment are provided in the outer portion 30.

In the present exemplary embodiment, the case 20 further includes a receiver portion 36 having a receiver groove 361 that receives the gasket 60. When the structural component 10 is attached to the top surface 101 of the target object 100, the receiver groove 361 is open to the top surface 101. A part of the gasket 60 protrudes from the receiver groove 361.

In the present exemplary embodiment, the case 20 further includes a groove portion 37 that receives the second gasket 65. The groove portion 37 is open to a cover 41 of the valve member 40. A part of the second gasket 65 protrudes from the groove portion 37.

In the present exemplary embodiment, as illustrated in FIGS. 4 and 5, the case 20 further includes a hole 371 provided in a face of the groove portion 37 to cause the groove portion 37 to communicate with a gap S between the sidewall 32 and the gasket 60.

In the present exemplary embodiment, the inner portion 27 and the outer portion 30 are integrally constructed. In the present exemplary embodiment, the communicating portion 25, the sidewall 32, the fastening portion 35, the shield portion 39, the receiver portion 36, and the groove portion 37 are integrally constructed. The case 20 may be a component made of an injection molding.

The case 20 may contain a resin. The target object 100 also may contain a resin.

The communicating portion 25 communicates with the flow path 103 of the target object 100. The communicating portion 25 has a hole penetrating the case 20. The communicating portion 25 may have a cylindrical shape. The communicating portion 25 is located inside the gasket 60 in a plan view.

The sidewall 32 is a part of the case 20 that defines an outer circumference of the case 20 in a plan view. The sidewall 32 surrounds the gasket 60 in a plan view. The sidewall 32 has a sidewall end 33 that faces the top surface 101 of the target object 100 when the structural component 10 is attached to the top surface 101. In the example illustrated in FIGS. 1 to 5, the sidewall 32 has an outer surface 34 that is perpendicular to the top surface 101 of the target object 100 when the structural component 10 is attached to the top surface 101. Although not illustrated, the outer surface 34 of the sidewall 32 may not be perpendicular and may not be parallel to the top surface 101 when the structural component 10 is attached to the top surface 101 of the target object 100.

In the example illustrated in FIG. 2, the sidewall 32 has a corner portion 321 that projects toward the outside of the structural component 10 in a plan view. In the example illustrated in FIG. 2, the sidewall 32 has a plurality of corner portions 321. The extent of the corner portion 321 is defined as follows. The outer profile L1 of the gasket 60 and the outer profile L2 of the case 20 in a plan view will be described below. Further, a figure A will be assumed below, which is similar to the outer profile L1 of the gasket 60, has the same orientation as that of the outer profile L2 of the gasket 60, and is inscribed at three or more points to the outer profile L2 of the case 20. A part of the sidewall 32 located outside the figure A in a plan view is considered to be the corner portion 321. Although not illustrated, it is not necessary that the sidewall 32 has the corner portion 321. In other words, the case 20 may have a shape that does not allow the figure A, which is inscribed at three or more points to the outer profile of the case 20, to be drawn and thus does not allow the extent of the corner portion 321 of the sidewall 32 to be determined.

In the present exemplary embodiment, the sidewall 32 has a plurality of the corner portions 321 (specifically, four corner portions 321).

The sidewall 32 has a drain portion 38. In the present exemplary embodiment, the sidewall 32 has a plurality of drain portions 38 (specifically, eight drain portions). In the present exemplary embodiment, the drain portions 38 of the sidewall 32 are provided at the corner portions 321. In the example illustrated in FIG. 2, the sidewall 32 has a plurality of corner portions 321, and a plurality of drain portions 38 is provided such that at least one of the fastening portions 35 is located at each of the corner portions 321. In particular, the drain portions 38 are provided so that two fastenings portions 35 are located at each of the corner portions 321. Details of the drain portion 38 will be described later.

The fastening portion 35 is a part of case 20 to be fastened to the top surface 101 of the target object 100. The case 20 of the present exemplary embodiment includes a plurality of fastening portions 35 (specifically, four fastening portions 35). The fastening portions 35 are arranged in a circumferential direction D2 along a circumference of the structural component 10 in a plan view. The fastening portions 35 may be spaced at equal intervals in the circumferential direction D2 along the circumference of the structural component 10 in a plan view. The fastening portions 35 each include a hole for a fastener to be inserted. The holes in the fastening portions 35 respectively overlap the fastening holes 105 in the target object 100. In the present exemplary embodiment, the fastening portion 35 is a columnar (specifically cylindrical) portion that is provided with the hole for the fastener to be inserted.

The fastening portion 35 is provided between the sidewall 32 and the gasket 60. Specifically, the fastening portion 35 is provided between the corner portion 321 of the sidewall 32 and the gasket 60. In the present exemplary embodiment, the sidewall 32 has a plurality of corner portions 321, and the fastening portions 35 are provided so that each one of the fastening portions 35 is positioned between corresponding one of the corner portions 321 and the gasket 60.

In the present exemplary embodiment, the fastening portions 35 are connected to the sidewall 32. Specifically, the fastening portions 35 are connected to the corner portions 321 of the sidewall 32. Further, the fastening portions 35 are connected to the receiver portion 36.

A gap S is defined between the sidewall 32 and the gasket 60. In the present exemplary embodiment, the gasket 60 is received in the receiver groove 361 of the receiver portion 36. The gap S is defined between the sidewall 32 and the receiver portion 36 that receives the gasket 60.

The shield portion 39 is a part that blocks the fluid from traveling from the outside of the structural component 10 toward the gasket 60 through the drain portion 38. The case 20 of the present exemplary embodiment includes a plurality of shield portions 39. In the present exemplary embodiment, the drain portions 38 are provided to the sidewall 32, where the shield portions 39 are provided such that at least one of the shield portions 39 corresponds to each of a plurality of drain portions 38. Specifically, the shield portions 39 are provided such that each of the drain portions 38 corresponds to one of the shield portions 39. Details of the shield portions 39 will be described later.

The valve member 40 includes a cover 41 that covers the communicating portion 25 of the case 20 in the closed position. The valve member 40 is movable from the closed position to open the communicating portion 25. The valve member 40 moves to open the communicating portion 25 when the pressure inside the target object 100 exceeds a threshold. In the structural component 10 illustrated in FIG. 1, when the pressure inside the target object 100 exceeds the threshold, the valve member 40 moves so that the cover 41 moves away from the case 20 in a first direction D1. The first direction D1 is a normal direction of the top surface 101 of the target object 100. Although not illustrated, the valve member 40 may be configured to move from the closed position in a direction other than the first direction D1 to open the communicating portion 25.

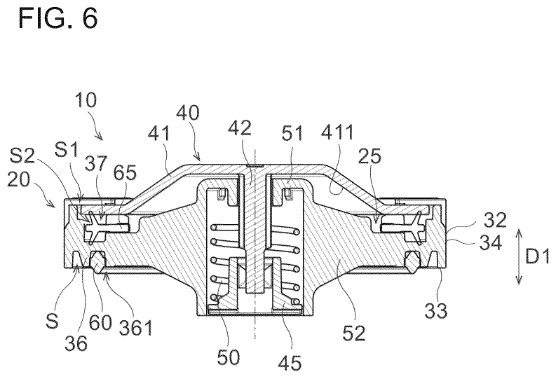

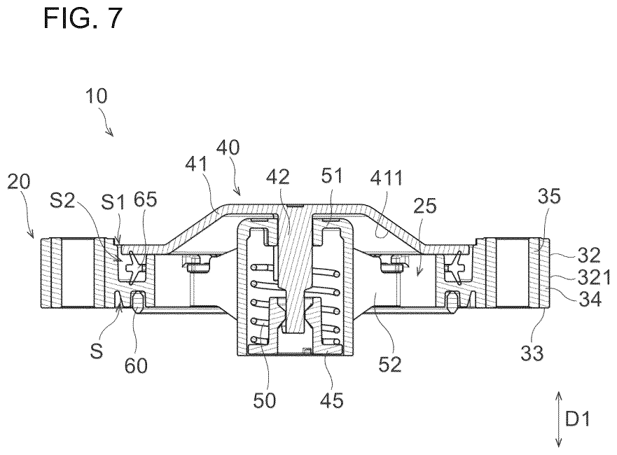

FIG. 6 is a cross-sectional view of the structural component 10 taken along a VI-VI line in FIG. 2. FIG. 7 is a cross-sectional view of the structural component 10 taken along a VII-VII line in FIG. 2. As illustrated in FIGS. 6 and 7, the structural component 10 may be equipped with an elastic member 50. The elastic member 50 biases the valve member 40 toward the target object 100 in the first direction D1. The elastic member 50 expands and contracts in the first direction D1 in response to the movement of the valve member 40 in the first direction D1. The elastic member 50 is, for example, a spring. When the pressure inside the target object 100 becomes greater than the biasing force applied on the valve member 40 by the elastic member 50, the valve member 40 moves away from the case 20 in the first direction D1.

The valve member 40 may include a shaft 42 extending from an inner surface 411 of the cover 41 toward the case 20. The inner surface 411 of the cover 41 is a surface of the cover 41 that faces the top surface 101 when the structural component 10 is attached to the top surface 101 of the target object 100. The shaft 42 may be inserted into the elastic member 50.

As illustrated in FIGS. 6 and 7, an end lock 45 may be attached to an end of the shaft 42. The end lock 45 may be in contact with an end of the elastic member 50.

As illustrated in FIGS. 6 and 7, the case 20 may include a stopper portion 51 that contacts an end of the elastic member 50 opposite the end of the elastic member 50 that contacts the end lock 45. As illustrated in FIG. 7, the case 20 may include beams 52 extending in the radial direction of the communicating portion 25 so as to connect the stopper portion 51 to the communicating portion 25.

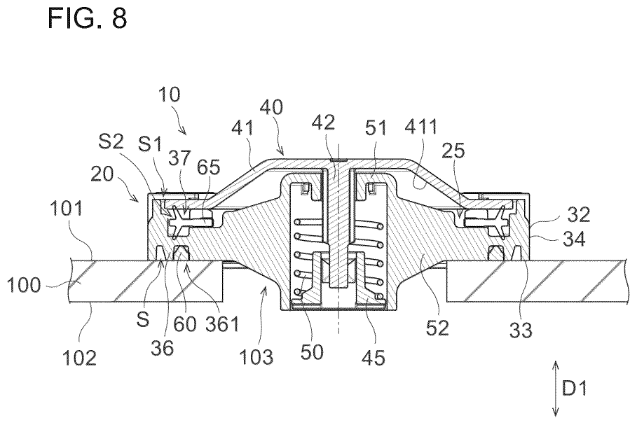

FIG. 8 is a cross-sectional view illustrating an example of the structural component 10 attached to the target object 100. In the cross-sectional view in FIG. 8, the structural component 10 is cut along the VI-VI line in FIG. 2 as in FIG. 6. As illustrated in FIG. 8, the gasket 60 may be placed while being compressed between the case 20 and the top surface 101 of the target object 100. The gasket 60 may include a compressible elastic material.

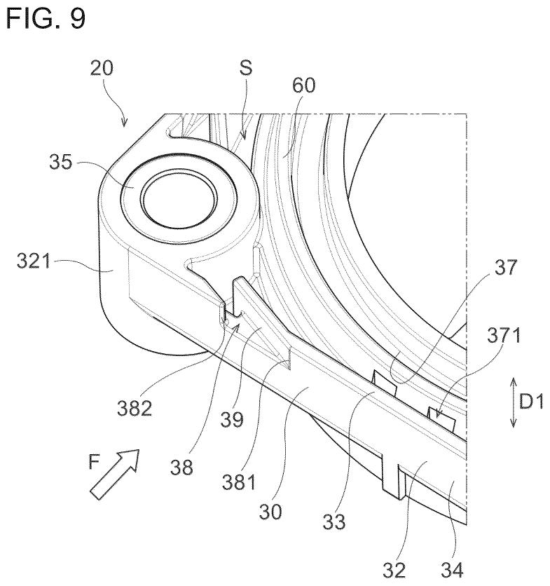

Details of the drain portion 38 will be described below. FIG. 9 is an enlarged view of one of the drain portions 38 and one of the shield portions 39 illustrated in FIG. 4. The drain portion 38 causes the gap S between the sidewall 32 and the gasket 60 to communicate with the outside of the structural component 10. In the example illustrated in FIG. 9, the drain portions 38 are each a notch formed in the sidewall end 33 of the sidewall 32. Although not illustrated, the drain portion 38 may be a through hole in the sidewall 32. In order to facilitate the formation of the drain portion 38 and the shield portion 39 corresponding to the drain portion 38 in manufacturing the structural component 10, it is preferable that the drain portion 38 is a notch formed in the sidewall end 33 of the sidewall 32.

The drain portion 38 provides the following advantages. External liquid sometimes enters the interior of the structural component 10 through a gap between the case 20 and the valve member 40. The structural component 10 of the present exemplary embodiment includes the second gasket 65 positioned between the case 20 and the valve member 40. In this case, external liquid possibly enters the interior of the structural component 10 through the gap between the second gasket 65, which is tightly attached to the case 20, and the valve member 40. As an example, external liquid possibly enters through a gap S1 between the case 20 and the valve member 40 illustrated in FIGS. 2, 6, and 7. If the structural component 10 is connected to an automobile, the external liquid in a form of water (especially muddy water) outside the automobile possibly enters the interior of the structural component 10. The liquid that has entered the interior of the structural component 10 can enter the gap S between the sidewall 32 and the gasket 60.

In contrast, according to the structural component 10 of the present exemplary embodiment, the liquid that has entered the gap S can be drained through the drain portion 38 that causes the gap S to communicate with the outside of the structural component 10.

In particular, the case 20 of the present exemplary embodiment has the groove portion 37 that is open to the cover 41 of the valve member 40 to receive the second gasket 65. In this case, the external liquid possibly enters the groove portion 37 through the gap S1. Specifically, the external liquid possibly enters a space S2 illustrated in FIGS. 6 and 7, which is located outside with respect to the second gasket 65 in the groove portion 37. In the present exemplary embodiment, the case 20 has the hole 371 in a face of the groove portion 37 that causes the groove portion 37 to communicate with the gap S between the sidewall 32 and the gasket 60. Therefore, the liquid that has entered the groove portion 37 can be drained into the gap S through the hole 371. In particular, the hole 371 causes the space S2 located outside with respect to the second gasket 65 in the groove portion 37 to communicate with the gap S between the sidewall 32 and the gasket 60. The liquid that has entered the space S2 thus can be drained into the gap S through the hole 371. According to the structural component 10 of the present exemplary embodiment, the liquid drained into the gap S can be further drained to the outside of the structural component 10 through the drain portion 38.

In the present exemplary embodiment, the drain portion 38 of the sidewall 32 is provided at the corner portion 321. The advantage of the above feature will be described below. In the present exemplary embodiment, the case 20 has the receiver portion 36 that receives the gasket 60 and the fastening portion 35 located outside the receiver portion 36. When the receiver portion 36 and the fastening portion 35 are to be formed in the case 20 of a restricted size, the case 20 is shaped so that the part provided with the fastening portion 35 protrudes outward from the outer profile L1 of the gasket 60. Due to the outwardly protruding portion provided with the fastening portion 35, the sidewall 32 near the fastening portion 35 forms the corner portion 321. The gap S of a relatively large size is formed between the corner portion 321 of the sidewall 32 and the gasket 60. The presence of the drain portion 38 in the corner portion 321 of the sidewall 32 allows the large gap S, which is formed between the corner portion 321 of the sidewall 32 and the gasket 60, to be used as a space for providing the drain portion 38 and the shield portion 39 corresponding to the drain portion 38.

Details of the shield portion 39 will be described below. The shape of the shield portion 39 is not limited as long as it is capable of blocking the fluid from traveling from the outside of the structural component 10 toward the gasket 60 through the drain portions 38. In the example illustrated in FIG. 9, the shield portion 39 is plate-shaped.

The arrangement of the shield portion 39 is not limited as long as it is capable of blocking the fluid from traveling from the outside of the structural component 10 toward the gasket 60 through the drain portion 38. In the example illustrated in FIG. 9, the shield portion 39 is located in the outer portion 30 of the case 20.

In the example illustrated in FIG. 9, the shield portion 39 is positioned at an inner side with respect to the outer surface 34 of the sidewall 32. The shield portion 39 is located in the gap S between the sidewall 32 and the gasket 60. Specifically, the shield portion 39 is located in the gap S between the corner portion 321 of the sidewall 32 and the gasket 60. Thus arranged shield portion 39 keeps the shield portion 39 from protruding outward from the outer surface 34 of the sidewall 32, thus reducing the size of the structural component 10.

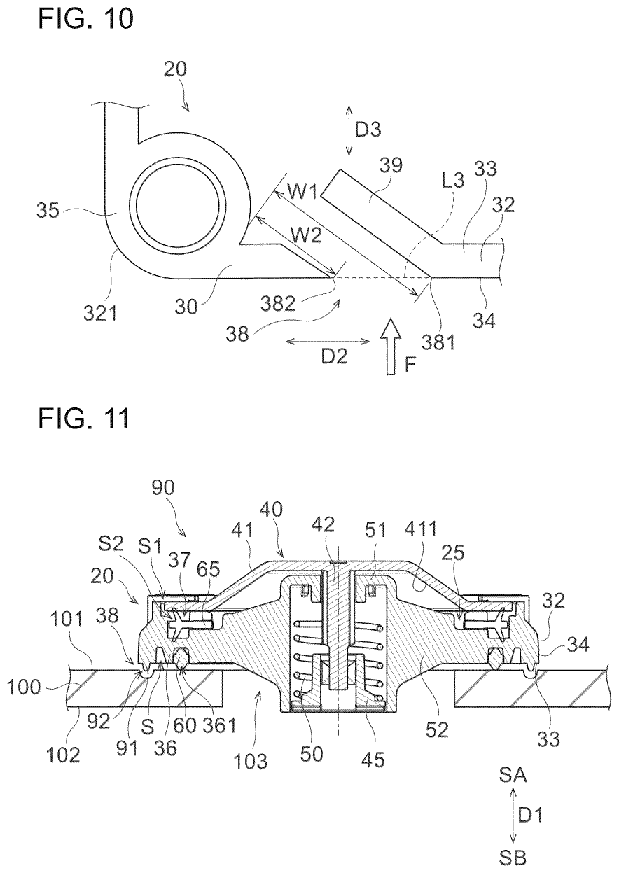

The advantages of the shield portion 39 will be described below. FIG. 10 is an illustration illustrating one of the drain portions 38 and one of the shield portions 39 together with a nearby part of the sidewall 32 as viewed in the first direction D1. FIG. 10 corresponds to a plan view of a part of the structural component 10. When, for example, the structural component 10 and the target object 100 are installed inside an automobile, fluid F sometimes hits the structural component 10 from the outside as illustrated in FIGS. 9 and 10. The fluid F is, for example, a jet of water released from a high-pressure washer. The pressure of the jet of the high-pressure washer is, for example, in a range from 5 kPa to 50 kPa. The shield portion 39 prevents the fluid F, which is traveling outside the structural component 10, from directly hitting the gasket 60 through the drain portion 38. Thus, damage to the gasket 60 can be suppressed. Further, the position of the gasket 60 can be prevented from being shifted due to the fluid F hitting thereon. Thus, leakage of the fluid inside the target object 100 to the outside of the target object 100 and the structural component 10 can be suppressed.

The drain portion 38 has a first end 381 and a second end 382 in a plan view. The first end 381 is an end in the circumferential direction D2 along the circumference of the structural component 10 in a plan view. The second end 382 is an end opposite the first end 381 in the circumferential direction D2. It is assumed that a straight line L3 connecting the first end 381 and the second end 382 is drawn. The line L3, which is a virtual straight line that can be drawn in a plan view of the structural component 10, is parallel to the top surface 101 when the structural component 10 is fixed to the top surface 101 of the target object 100. Further, a direction D3 perpendicular to the straight line L3 in a plan view is assumed. The direction D3 is a direction parallel to the top surface 101 when the structural component 10 is fixed to the top surface 101 of the target object 100. In the example illustrated in FIG. 10, the shield portion 39 overlaps the entire drain portion 38 when viewed in the direction D3 perpendicular to the straight line L3. Thus arranged shield portion 39 can suppress direct hit by the fluid F on the gasket 60 through the drain portion 38.

In the example illustrated in FIG. 9, the shield portion 39 is connected to the first end 381. The shield portion 39 is not connected to the second end 382. The shield portion 39 is thus supported by the first end 381, so that the shield portion 39 is less likely to be damaged by the fluid F hitting thereon. Further, the flow path of the fluid F entering the drain portion 38 can be restricted. Thus, hit by the fluid F on the gasket 60 can be suppressed more effectively. In the example illustrated in FIG. 9, the shield portion 39 is connected to the case 20 at one of the ends in the first direction D1. The shield portion 39 is thus supported by a part of the case 20 connected to the shield portion 39, so that the shield portion 39 is more unlikely to be damaged by the fluid F hitting thereon. In addition, the flow path of the fluid F entering the drain portions 38 can be further restricted. Although not illustrated, the shield portion 39 may be connected to the second end 382 and not to the first end 381. Alternatively, the shield portion 39 may be connected to the case 20 at one of the ends in the first direction D1 without being connected to the first end 381 or the second end 382.

In the example illustrated in FIGS. 9 and 10, the face of the shield portion 39 is non-parallel to the outer surface 34 of the sidewall 32. Although not illustrated, the face of the shield portion 39 may be entirely or partially parallel to the outer surface 34 of the sidewall 32.

As illustrated in FIG. 10, in a plan view, a distance w2 between the second end 382 and the fastening portion 35 is smaller than a distance w1 between the first end 381 and the fastening portion 35. When the case 20 includes a plurality of fastening portions 35, the smallest distance between each of the fastening portions 35 and corresponding one of the first ends 381 is used as the distance w1. Further, the smallest distance between each of the fastening portions 35 and corresponding one of the first ends 381 is used as the distance w2. As described above, the following advantages are achieved by the shield portion 39 connected to the first end 381 and the distance w2 smaller than the distance w1. With the shield portion 39 connected to the first end 381, the fluid F entering the drain portion 38 is deflected by the shield portion 39 toward the second end 382 closer to the fastening portion 35. The fluid F having entered the drain portion 38 thus can be deflected toward the fastening portion 35. The fastening portion 35, which includes a hole for the fastener to be inserted, is designed to be relatively strong. By directing the fluid F toward the fastening portion 35 and receiving the fluid F by the fastening portion, the fluid F can be prevented from hitting on other parts of the structural component 10, especially those parts that are less rigid than the fastening portion 35.

To further describe the advantages of the structural component 10 of the present exemplary embodiment, a structural component 90 illustrated in FIG. 11 will be described below as a comparative example. The same symbols are used in the structural component 90 of the comparative example illustrated in FIG. 11 for the same components as those in the structural component 10 of the present exemplary embodiment illustrated in FIGS. 1 to 10.

In the structural component 90 of the comparative example, the drain portion 38 has a concave-convex structure. Specifically, the drain portion 38 has a convex portion 91 defined by a part of the sidewall end 33 of the sidewall 32 protruding toward the top surface 101 of the target object 100. A concave portion 92 is formed on the top surface 101 of the target object 100 at a position facing the convex portion 91. A part of the convex portion 91 is inserted into the concave portion 92. A gap is provided between the convex portion 91 and the concave portion 92. It is believed that the structural component 90 of the comparative example can also suppress direct hit by the fluid F on the gasket 60 through the drain portion 38 while draining the fluid in the gap S to the outside of the structural component 10 through the drain portion 38. However, the structural component 90 of the comparative example not only requires the convex portion 91 to be provided on the sidewall 32 of the case 20 of the structural component 10 but also requires the concave portion 92 to be provided on the top surface 101 of the target object 100. Accordingly, the necessity for providing the concave portion 92 on the target object 100 increases the cost required for the work for attaching the structural component 90 to the top surface 101 of the target object 100. In contrast, the structural component 10 of the present exemplary embodiment can be attached to the top surface 101 of the target object 100 without forming the concave or convex portion on the top surface 101 of the target object 100. In other words, as illustrated in FIG. 8, a part of the top surface 101 of the target object 100 that overlaps the drain portion 38 in the first direction D1 can be made flat. The cost for attaching the structural component to the top surface 101 of the target object 100 thus can be reduced as compared with the structural component 90 in the comparative example.

Further, when the liquid in the gap S is drained to the outside of the structural component 10 through the drain portion 38 in the structural component 90 of the comparative example, the liquid has to change the flow path many times along the gap between the convex portion 91 and the concave portion 92 before being drained to the outside of the structural component 10. Specifically, the liquid must flow to a first side SA in the first direction D1 illustrated in FIG. 11 and then to a second side SB in the first direction D1 in order to be drained to the outside of the structural component 10. In contrast, according to the structural component 10 of the present exemplary embodiment, the flow path of the liquid can be simplified in draining the liquid in the gap S to the outside of the structural component 10 through the drain portion 38. Especially, the flow path of the liquid can be designed so that the liquid can be drained out of the structural component 10 without flowing in the first direction D1. In addition, the flow path of the liquid can be linearly designed.

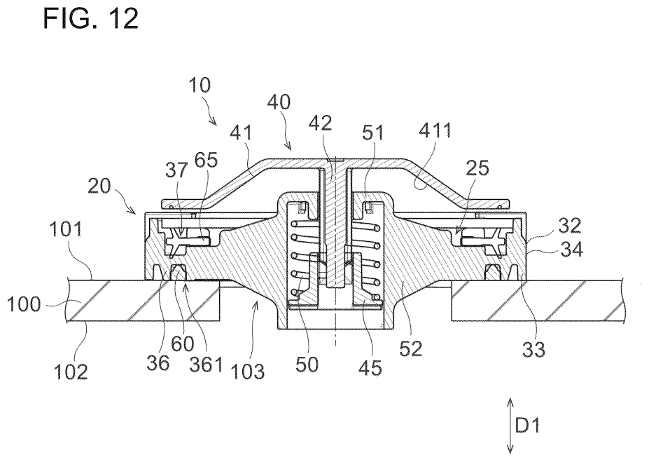

FIG. 12 is a cross-sectional view illustrating an example of an operation of the structural component 10, which is configured as a pressure relief valve. When the pressure inside the target object 100 exceeds a threshold, the valve member 40 moves so that the cover 41 moves away from the case 20 in the first direction D1. A flow path is thus created between the cover 41 and the case 20.

As a fluid such as a gas or the like inside the target object 100 is released through the flow path to the outside of the structural component 10, the pressure inside the target object 100 decreases. When, for example, the target object 100 is a battery pack housing, the explosion of the battery pack thus can be prevented. As described above, the structural component 10 configured as a pressure relief valve contributes to the improvement of safety of the battery pack.

When the pressure inside the target object 100 becomes smaller than the force applied to the valve member 40 by the elastic member 50, the valve member 40 moves toward the case 20. The flow path 103 of the target object 100 is thus sealed again by the valve member 40.

It is also possible to combine multiple components disclosed in the above exemplary embodiment as necessary. Alternatively, some component(s) may be removed from all the components described in the above exemplary embodiment.

While the invention has been explained with reference to the specific embodiment of the invention, the invention is not limited to the specific embodiment and the invention is limited only by the appended claims.

### REFERENCE SIGNS LIST

10 Structural component
20 Case
25 Communicating portion
27 Inner portion
30 Outer portion
32 Sidewall
321 Corner portion
33 Sidewall end
35 Fastening portion
36 Receiver portion
361 Receiver groove
37 Groove portion
371 Hole
38 Drain portion
381 First end
382 Second end
39 Shield portion
40 Valve member
41 Cover
60 Gasket
65 Second gasket
100 Target object
101 Top surface

What is claimed is:

1. A structural component configured to be attached to a surface of a target object having a flow path, the structural component comprising:
a case including a communicating portion configured to communicate with the flow path of the target object;
a valve member including a cover that covers the communicating portion in a closed position of the valve member, the valve member being movable from the closed position to open the communicating portion; and
a gasket configured to be interposed between the surface of the target object and the case, and to surround the flow path in a plan view, wherein
the case includes a sidewall surrounding the gasket in a plan view,
the sidewall includes a drain portion configured to communicate a gap between the sidewall and the gasket with an outside of the structural component, and
the case further includes a shield portion that is configured to block a fluid from traveling from the outside of the structural component toward the gasket through the drain portion.

2. The structural component according to claim 1, wherein
the drain portion includes a first end, which is an end in a circumferential direction along a circumference of the structural component in a plan view, and a second end opposite the first end in the circumferential direction, and
the shield portion overlaps an entirety of the drain portion when viewed in a direction perpendicular to a straight line connecting the first end and the second end.

3. The structural component according to claim 1, wherein
the drain portion includes a first end, which is an end in a circumferential direction along a circumference of the structural component in a plan view, and a second end opposite the first end in the circumferential direction, and
the shield portion is connected to the first end.

4. The structural component according to claim 3, wherein
the case further includes a fastening portion interposed between the sidewall and the gasket, and configured to be fastened to the surface of the target object, and
in a plan view, a distance between the second end and the fastening portion is configured to be smaller than a distance between the first end and the fastening portion.

5. The structural component according to claim 1, wherein
the sidewall includes a corner portion protruding toward an outside of the structural component in a plan view,
the case further includes a fastening portion provided between the corner portion of the sidewall and the gasket and configured to be fastened to the surface of the target object, and
the sidewall includes the drain portion at the corner portion.

6. The structural component according to claim 1, wherein
the sidewall includes a sidewall end configured to face the surface of the target object when the structural component is configured to be attached to the surface of the target object, and
the drain portion is a notch formed in the sidewall end.

7. The structural component according to claim 1, further comprising:
a second gasket interposed between the case and the valve member, and surrounding the communicating portion in a plan view, wherein
the case further includes a groove portion that is open to the cover of the valve member to receive the second gasket, and a hole provided in a face of the groove portion to cause the groove portion to communicate with the gap between the sidewall and the gasket.

8. The structural component according to claim 1, wherein the target object is configured to be an enclosure of a battery pack.
